(19) United States
(12) Patent Application Publication
(10) Pub. No.: US 2023/0006336 A1
(43) Pub. Date: Jan. 5, 2023

(54) Antenna Assembly and Electronic Device

(71) Applicant: GUANGDONG OPPO MOBILE TELECOMMUNICATIONS CORP., LTD., Dongguan (CN)

(72) Inventor: Fan Yang, Dongguan (CN)

(21) Appl. No.: 17/941,001

(22) Filed: Sep. 8, 2022

Related U.S. Application Data
(63) Continuation of application No. PCT/CN2021/073689, filed on Jan. 26, 2021.

(30) Foreign Application Priority Data
Mar. 12, 2020 (CN) 202010169499.4
Mar. 12, 2020 (CN) 202020306607.3

(51) Int. Cl. H01Q 1/24; H01Q 1/38; H01Q 9/30

(52) U.S. Cl. CPC H01Q 1/243; H01Q 1/38; H01Q 9/30

(57) ABSTRACT

An antenna assembly may include a conductive frame, a resonant module and a signal source module. The conductive frame may define at least one slot, the slot may at least divide the conductive frame into a first conductive branch and a second conductive branch. A first feed point may be provided on the first conductive branch, and a second feed point may be provided on the second conductive branch. The resonant module may include a first resonant circuit and a second resonant circuit. The first signal source may feed a first current signal to the first conductive branch, to generate a plurality of resonant frequencies on the first conductive branch. The second signal source may feed a second current signal to the second conductive branch via the second resonant circuit and the second feed point, to generate at least one resonant frequency.

### CROSS-REFERENCE TO RELATED APPLICATION(S)

The present disclosure is a continuation-application of International (PCT) Patent Application No. PCT/CN2021/073689 filed on Jan. 26, 2021, which claims priorities to Chinese Patent Application Nos. 202010169499.4 and 202020306607.3, both filed on Mar. 12, 2020, the entire contents of all of which are hereby incorporated by reference.

### TECHNICAL FIELD

The present disclosure relates to a technical field of antennas, and in particular to an antenna assembly and an electronic device.

### BACKGROUND

Background information related to the present disclosure is provided by the statements herein which are not necessary to constitute the exemplary related art.

With the development of wireless communication technology, requirements for portability and appearances of electronic devices by users become higher and higher. An antenna of an electronic device including a metal frame is mainly realized based on the metal frame. A profile height of the metal frame is one of the main factors affecting a radiation efficiency of the metal frame. The profile height of the metal frame of the electronic device may be understood as a metal width of the metal frame in a thickness direction of a cellphone. Under a trend of pursuing an ultimate performance of an appearance of the cellphone, a design for a frame having a low profile height makes a new challenge to a performance of the antenna.

### SUMMARY

An antenna assembly and an electronic device are provided in various embodiments of the present disclosure.

According to a first aspect of the present disclosure, an antenna assembly is provided. The antenna assembly may include a conductive frame, a resonant module and a signal source module. The conductive frame may define at least one slot. The conductive frame may be divided by the slot at least into a first conductive branch and a second conductive branch separate from each other. A first feed point may be provided on the first conductive branch. A second feed point may be provided on the second conductive branch. The resonant module may include a first resonant circuit and a second resonant circuit. The signal source module may include a first signal source and a second signal source. The first signal source may be coupled to the first conductive branch via the first resonant circuit and the first feed point, and feed a first current signal to the first conductive branch, such that a plurality of resonant frequencies may be generated in the first conductive branch. A first radio frequency signal including a plurality of operating frequency bands may be radiated. The second signal source may be coupled to the second conductive branch via the second resonant circuit and the second feed point, and feed a second current signal to the second conductive branch, such that at least one resonant frequency may be generated in the second conductive branch. A second radio frequency signal including at least an operating frequency band may be radiated.

According to a second aspect of the present disclosure, an electronic device is provided. The electronic device may include a substrate and an antenna assembly as mentioned above. The substrate may be accommodated in a cavity enclosed by the conductive frame. The resonant module and the signal source module are arranged on the substrate.

Details of one or more embodiments of the present disclosure are illustrated in accompanying drawings and descriptions in the following. Other features, purposes, and advantages of the present disclosure will become apparent in the specification, drawings and claims.

### BRIEF DESCRIPTION OF DRAWINGS

In order to more clearly describe the technical solutions in the embodiments of the present disclosure, the following will briefly introduce the drawings required in the description of the embodiments. Obviously, the drawings in the following description are only some embodiments of the present disclosure. For those skilled in the art, other drawings can be obtained based on these drawings without creative work.

FIG. 1 is a perspective, structural schematic view of an electronic device according to an embodiment of the present disclosure.

FIG. 2 is a first structural schematic view of an antenna assembly of the electronic device according to an embodiment of the present disclosure.

FIG. 3 is a second structural schematic view of the antenna assembly of the electronic device according to an embodiment of the present disclosure.

FIG. 4a is a simulation schematic view of a S11 parameter of the antenna assembly according to an embodiment of the present disclosure.

FIG. 4b is a simulation schematic view of efficiency of the antenna assembly according to an embodiment of the present disclosure.

FIG. 5 is a third structural schematic view of the antenna assembly of the electronic device according to an embodiment of the present disclosure.

FIG. 6 is a simulation schematic diagram of a S11 parameter of the antenna assembly according to another embodiment of the present disclosure.

FIG. 7 is a fourth structural schematic view of the antenna assembly of the electronic device according to an embodiment of the present disclosure.

FIG. 8 is a fifth structural schematic view of the antenna assembly of the electronic device according to an embodiment of the present disclosure.

FIG. 9 is a sixth structural schematic view of the antenna assembly of the electronic device according to an embodiment of the present disclosure.

### DETAILED DESCRIPTION

In order to make purposes, technical solutions, and advantages of the present disclosure more clear and more understandable, the present disclosure will be further described in detail in the following with reference to the accompanying drawings and embodiments. It should be understood that specific embodiments described herein are only configured to explain the present disclosure, but not to limit the present disclosure.

It can be understood that terms such as “first”, “second, etc., used in the present disclosure may be configured to describe various elements herein. The various elements are not limited to the terms. The terms are simply configured to distinguish a first element from another element, and not intended to indicate or imply relative importance or significance or to imply the number of indicated technical features. Thus, the feature defined with “first”, “second”, or the like may include one or more of such a feature. In the description of the present disclosure, it should be noted that “a plurality of” or “multiple” means two or more, unless specified otherwise.

It should be noted that a description of an element being “attached to” another element may indicate that the element is directly on the another element or that an intervening element may exist. When an element is considered to be “connected to” another element, the element may be directly connected to the another element, or an intervening element may exist simultaneously.

An antenna assembly according to an embodiment of the present disclosure is applied to an electronic device. In an embodiment, the electronic device may include the cellphone, a tablet computer, a notebook computer, a palmtop computer, a Mobile Internet Device (MID), a wearable device (such as a smart watch, a smart bracelet, a pedometer, etc.) or other communication modules capable of arranging an array-antenna assembly.

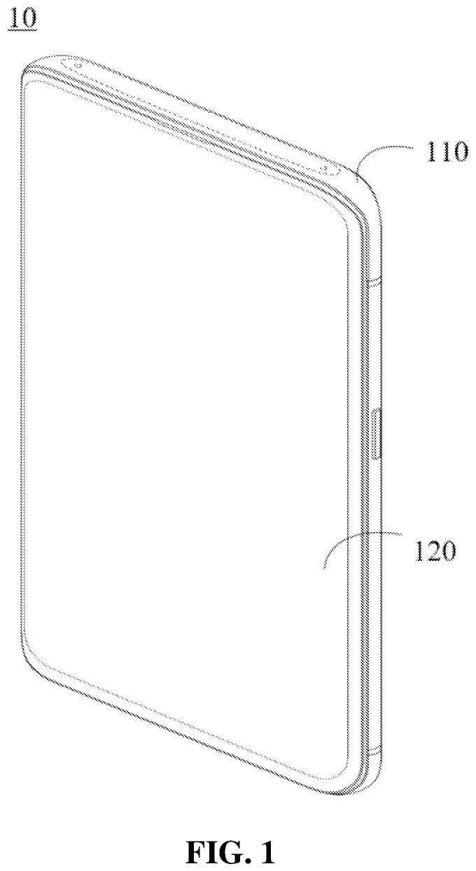

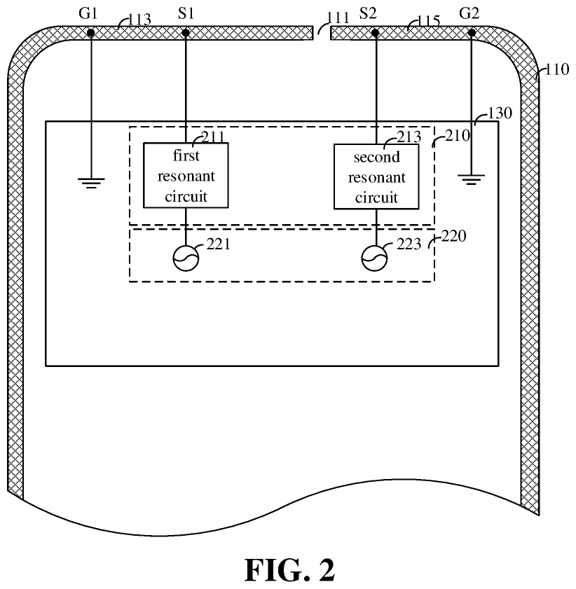

As shown in FIG. 1, in some embodiments of the present disclosure, the electronic device 10 may include a conductive frame 110, a rear cover, a display screen assembly 120, a substrate 130 (see FIG. 2) and a radio frequency circuit. The display screen assembly 120 is fixed on a housing assembly. The housing assembly includes the conductive frame 110 and the rear cover. An external structure of the electronic device 10 may include the display screen assembly 120 and the housing assembly. The display screen assembly 120 may be configured to display pictures or characters, and provide an operating interface for a user.

The rear cover is configured to define an outer contour of the electronic device 10. The rear cover may be integrally formed. During a process of forming the rear cover, a structure such as a rear camera hole, a fingerprint-identifying module, a mounting hole of the antenna assembly or the like, may be defined or arranged on the rear cover. The rear cover may be a non-metal rear cover. For example, the rear cover may be a plastic rear cover, a ceramic rear cover, a 3D glass rear cover or the like.

In some embodiments, the conductive frame 110 may be a frame structure defining a through hole. A material of the conductive frame 110 may include a metal frame such as an aluminum alloy metal frame, a magnesium alloy metal frame or the like.

In some embodiments, the conductive frame 110 may be a rectangular frame with rounded corners. The conductive frame 110 may include a first frame and a third frame opposite to the first frame. The conductive frame 110 may include a second frame and a fourth frame opposite to the second frame. The second frame is connected to the first frame and the third frame. The first frame may be regarded as a top frame of the electronic device 10. The third frame may be regarded as a bottom frame of the electronic device 10. The second frame and the fourth frame may be regarded as side frames of the electronic device 10.

The antenna assembly may be partially or wholly formed of a portion of the conductive frame 110 of the electronic device 10. In some embodiments, a radiator of the antenna assembly may be partially or fully integrated on at least one of the top frame, the bottom frame, a first side frame, and a second side frame of the electronic device 10.

The substrate 130 may be accommodated in an accommodating space defined by the conductive frame 110 and the rear cover. The substrate 130 may be a printed circuit board (PCB) or a flexible printed circuit (FPC). A part of a radio frequency circuit for processing radio frequency signals may be integrated on the substrate 130. A controller capable of controlling operations of the electronic device 10 may also be integrated on the substrate 130. The radio frequency circuit may include but is not limited to the antenna assembly, at least one amplifier, a transceiver, a coupler, a low noise amplifier (LNA), a duplexer or the like. In addition, the radio frequency circuit may also communicate with a network and other devices by means of a wireless communication. The wireless communication mentioned above may adopt any communication standard or protocol that includes but is limited to a global system of mobile communication (GSM), a general packet radio service (GPRS), a code division multiple access (CDMA), a wideband code division multiple access (WCDMA), a long term evolution (LTE), email, a short messaging service (SMS), etc.

As shown in FIG. 2, an antenna assembly is provided in some embodiments of the present disclosure. The antenna assembly include the conductive frame 110, a resonance module 210 and a signal source module 220.

At least one slot 111 may be defined in the conductive frame 110. The conductive frame 110 may be divided by the at least one slot 111 at least into a first conductive branch 113 and a second conductive branch 115 separate from each other.

In an embodiment, the slot 111 is a part of the antenna assembly, and may be understood as a slit. The conductive frame 110 may be divided into at least two independent conductive branches by the slit. For example, one slot 111 may be configured to divide the conductive frame 110 into the first conductive branch 113 the second conductive branch 115 separating from each other. When the number of the at least one slot 111 is N, the conductive frame 110 may be divided into N+1 independent conductive branches.

In some embodiments, the slot 111 may be filled with air, plastic and/or other dielectrics.

In some embodiments, a shape of the slot 111 may be substantially straight. Alternatively, the slot 111 may have one or more curved shapes.

It should be noted that, the slot 111 may be defined in any position of the conductive frame 110. In some embodiments of the present disclosure, the shape, a size, the number of the at least one slot 111, and the position where the slot 111 is defined in the conductive frame 110 are not further limited.

Each conductive branch may be provided with a corresponding feed point. A first feed point S1 may be arranged on the first conductive branch 113. A second feed point S2 may be arranged on the second conductive branch 115. In some embodiments, the first feed point S1 may be provided in a middle position of the first conductive branch 113.

The resonant module 210 may include a first resonant circuit 211 and a second resonant circuit 213.

The signal source module 220 may include a first signal source 221 and a second signal source 223. The first signal source 221 may be configured to output a first current signal. The second signal source 223 may be configured to output a second current signal.

The first resonant circuit 211 may filter and tune the received first current signal, such that a plurality of resonant frequencies may be excited on the first conductive branch 113 after a tuned first current signal is fed to the first conductive branch 113. In this way, a first radiator on the first conductive branch 113 may be enabled to radiate a first radio frequency signal with a plurality of operating frequency bands.

Further, the first resonant circuit 211 may further configured to filter out radio frequency signals other than a frequency corresponding to the first current signal, such that the first current signal is in a state of conduction or in a ON state when flowing through the first resonant circuit 211.

The second resonant circuit 213 may filter and tune the received second current signal, such that at least one resonant frequency may be excited on the second conductive branch 115 after a tuned second current signal is fed to the second conductive branch 115. In this way, a second radiator on the second conductive branch 115 may be enabled to radiate a second radio frequency signal with at least an operating frequency band.

Further, the second resonant circuit 213 may further be configured to filter out radio frequency signals other than a frequency corresponding to the second current signal, such that the second current signal is in a state of conduction or in a ON state when flowing through the second resonant circuit 213.

According to the antenna assembly described above, the conductive frame 110 may be divided into the first conductive branch 113 and the second conductive branch 115 through defining the slot 111 in the conductive frame 110. The plurality of resonant frequencies may be excited on the first conductive branch 113 through the first resonant circuit 211, such that the first radiator of the first conductive branch 113 may radiate the first radio frequency signal with a plurality of operating frequency bands simultaneously. The at least one resonant frequency may be excited on the second conductive branch 115 through the second resonant circuit 213, such that the second radiator of the second conductive branch 115 may radiate the second radio frequency signal with at least one operating frequency band simultaneously. In this way, a design of the antenna having dual conductive branches sharing a common aperture may be achieved, such that the first radio frequency signal and the second radio frequency signal may share a common slot, and space-utilizing rates of the slot 111 and the conductive frame 110 of the electronic device 10 may be increased. In addition, there is no need to design an antenna radiator arranged separately, thereby reducing a thickness of the cellphone.

In some embodiments, the first radiator and the second radiator may be integrated on the first frame or the third frame of the electronic device 10, such that a utilizing rate of the top frame or a utilizing rate of the bottom frame may be increased, and a pressure of integrating the antenna assembly on the side frames may be reduced. In this way, the profile heights of the side frames may be reduced, and the profile heights of the side frames may be reduced to values being less than 1 mm. The profile heights of the side frames may be regarded as metal widths of the metal frame in a thickness direction of the electronic device 10. A profile height of the conductive frame 110 is one of the main factors affecting a radiating efficiency of the conductive frame 110. Under a background that a curvature of a side surface of a curved screen is getting larger and larger, even if antenna clearances of the side frames configured for integrating the antennas are greatly reduced, the antenna assembly may be integrated on the top frame or the bottom frame, without affecting flexibility and performances of the antenna assembly.

In some embodiments, the operating frequency bands of the first radio frequency signal may include two operating frequency bands of an LTE signal, an operating frequency band of a satellite positioning signal and a first operating frequency band of a Wi-Fi signal.

The LTE signal may be divided into a Low band (LB) signal, a Middle band (MB) signal and a High band (HB) signal. In some embodiments of the present disclosure, the two operating frequency bands of the LTE signal may include the MB signal and the HB signal. A frequency range of the MB signal may be in the range of 1710 MHz to 2170 MHz A frequency range of the HB signal may be in the range of 2300 MHz to 2690 MHz

The satellite positioning signal may include at least one of a Global Positioning System (GPS) signal with a frequency range of 1.2 GHz-1.6 GHz, a BeiDou Navigation Satellite System (BDS) signal, and a Global Navigation Satellite System (GLONASS) signal. In some embodiments of the present disclosure, an operating frequency band of the satellite positioning signal may include an L1 frequency band.

An operating frequency band of the Wi-Fi signal may include 2400 MHz-5000 MHz.

In some embodiments of the present disclosure, the first operating frequency band of the Wi-Fi signal may be a 2.4G frequency band.

In some embodiments, the operating frequency band of the second radio frequency signal may include: two operating frequency bands of a 5G signal; and a second operating frequency band of the Wi-Fi signal.

Specifically, the operating frequency bands of the 5G signal may at least include an N78 frequency band and an N79 frequency band. The frequency range of the N78 frequency band may be in the range of 3.3 GHz 3.6 GHz. The frequency range of the N79 frequency band may be in the range of 4.8 GHz 5 GHz. The second operating frequency band of the Wi-Fi signal may be a Wi-Fi 5G signal frequency band. In some embodiments of the present disclosure, under an action of the first resonant circuit 211, the first current signal may be fed into the first conductive branch 113 via the first feed point S1, and excite the first radio frequency signal in the first conductive branch 113. The first radio frequency signal may include resonant frequencies resonating in an MHB frequency band of the LTE, an L1 frequency band of the GPS signal and a 2.4G frequency band of the WIFI signal. In this way, at least two resonant frequencies in the MHB frequency band of the LTE, the L1 frequency band of the GPS signal and the 2.4G frequency band of the Wi-Fi signal are generated in the first conductive branch 113. Therefore, the first radiator of the first conductive branch 113 may realize the first radio frequency signal that radiates the MHB frequency band of the LTE, the L1 frequency band of the GPS signal and the 2.4G frequency band of the Wi-Fi signal simultaneously. Under an action of the second resonant circuit 213, the second current signal may be fed into the second conductive branch 115 via the second feed point S2, and excite, in the second conductive branch 115, the second current signal resonating in the N78 frequency band and the N79 frequency band of the 5G signal and in the 5G frequency band of the Wi-Fi signal. In this way, the second radiator of the second conductive branch 115 may realize the second radio frequency signal that radiates the at least one frequency band of the N78 frequency band and the N79 frequency band of the 5G signal and the 5G frequency band of the Wi-Fi signal simultaneously.

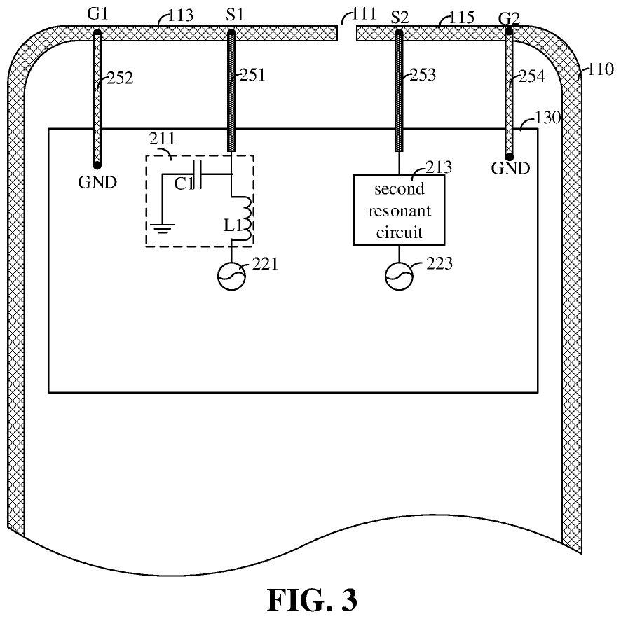

As shown in FIG. 3, in some embodiments, the first conductive branch 113 may further be provided with a first ground-returning point G1. The first ground-returning point G1 may be arranged at a side of the first feed point S1 away from the slot 111. The first conductive branch 113 between the slot 111 and the first ground-returning point G1 may form the first radiator.

The first signal source 221 and the first resonant circuit 211 may both be arranged on the substrate 130. The first resonant circuit 211 may be coupled to the first conductive branch 113 via a first electrical feeding part 251. The first electrical feeding part 251 may be a conductive elastic sheet or a screw. A coupling point between the conductive elastic sheet or the screw and the first conductive branch 113 may be the first feed point S1. The first feed point S1 may be connected to the first resonant circuit 211 through the first electrical feeding part 251. The first current signal output from the first signal source 221 may pass through the first resonant circuit 211, and then be fed into the first conductive branch 113 via the first feed point S1 by feeding of the elastic sheet or the screw. In this way, a current signal for generating a plurality of resonant frequencies may be excited in the first radiator.

In some embodiments, the first ground-returning point G1 may be connected to a ground layer of the substrate 130 through the first connection portion 252, such that a connectivity of the first ground-returning point G1 with the ground may be realized. The first connection portion 252 may be a conductor or a flexible circuit board. The conductor may be an elastic sheet or a screw or the like. The first connection portion 252 may also be a connection arm. The connection arm may be made from the same material as the first conductive branch 113. For example, the first connection portion 252 and the first conductive branch 113 may be integrally formed, to simplify the structure of the antenna assembly.

In some embodiments, the first resonant circuit 211 may include a low-pass filter circuit. The first conductive branch 113 may be configured to generate two resonant frequencies under the resonant action of the first resonant circuit 211.

It should be appreciated that, the low-pass filter circuit is configured as: when the first current signal passes, the first resonant circuit 211 is in an ON or conductive state; and a non-first current signal with a frequency higher than that corresponding to the first current signal is blocked and could not pass the first resonant circuit 211.

In some embodiments, the low-pass filter circuit may include a first capacitor C1 and a first inductor L1. A first end of the first inductor L1 may be connected to a first end of the first capacitor C1 and the first feed point S1. A second end of the first inductor L1 may be connected to the first signal source 221. A second end of the first capacitor C1 may be grounded.

It should be noted that, the low-pass filter circuit may be formed of other components, and is not limited to the embodiments illustrated in the present disclosure.

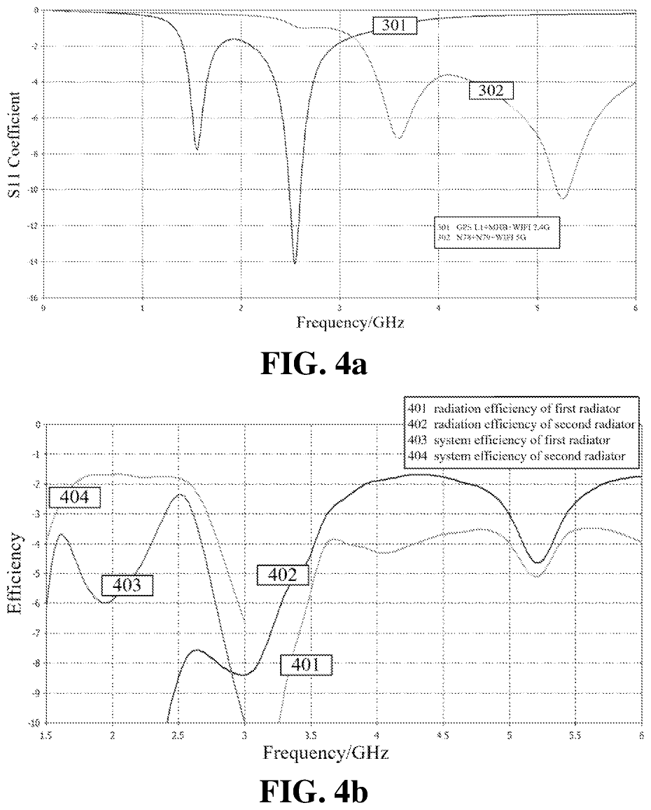

As shown in FIGS. 4a and 4b, by arranging the first resonant circuit 211 in the antenna assembly, dual resonant frequencies may be generated in the first conductive branch 113. One resonant frequency of the dual resonant frequencies is the L1 frequency band of the GPS signal, the other resonant frequency of the dual resonant frequencies is the 2.4G frequency band of the Wi-Fi signal. When the first radiator of the first conductive branch 113 radiates the first radio frequency signal, the total efficiency and the radiation efficiency of the first radiator radiating each operating frequency band of the first radio frequency signal meet the communication requirements. As shown in FIG. 4a, a curve 301 illustrate the S11 coefficient of the first radio frequency signal, a curve 302 illustrate the S11 coefficient of the second radio frequency signal. As shown in FIG. 4b, a curve 401 illustrates the radiation efficiency of the first radiator, a curve 402 illustrates the radiation efficiency of the second radiator, a curve 403 illustrates the system efficiency of the first radiator, and a curve 404 illustrates the system efficiency of the second radiator.

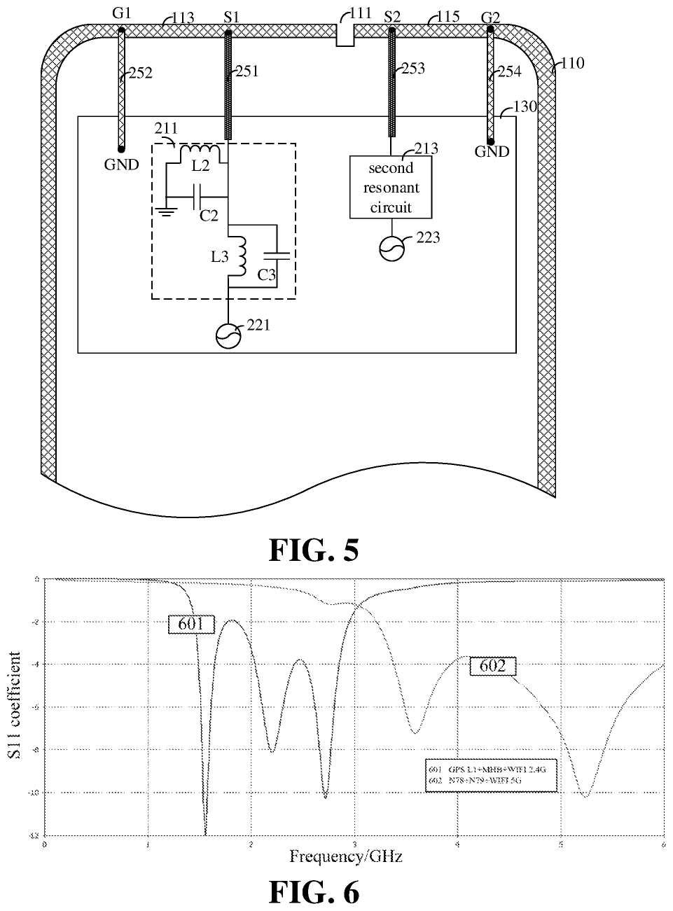

As shown in FIG. 5, in some embodiments, the first resonant circuit 211 may include a band-stop and band-pass circuit. Three resonant frequencies may be generated in the first conductive branch 113 under the resonance adjustment of the first resonant circuit 211.

In some embodiments, the band-stop and band-pass circuit may include a second capacitor C2, a third capacitor C3, a second inductor L2 and a third inductor L3. A first end of the second inductor L2 and a first end of the second capacitor C2 are both grounded. A second end of the second inductor L2 may be connected to the first feed point S1, a second end of the second capacitor C2, a first end of the third capacitor C3 and a first end of the third inductor L3. A second end of the third capacitor C3 and a second end of the third inductor L3 may both be connected to the first signal source 221.

It should be appreciated that, the band-stop and band-pass circuit is configured as: when the first current signal passes, the first resonant circuit 211 is in an ON state or in a conductive state; and a non-first current signal with a frequency higher or lower than that corresponding to the first current signal is blocked and could not pass the first resonant circuit 211.

It should be noted that, the band-stop and band-pass circuit may be formed of other components, and is not limited to the embodiments illustrated in the present disclosure.

As shown in FIG. 6, by arranging the first resonant circuit 211 in the antenna assembly, three resonant frequencies may be generated in the first conductive branch 113. A first one of the three resonant frequencies is the L1 frequency band of the GPS signal, a second one of the three resonant frequencies is the medium-high frequency signal frequency band of the LTE signal, and a third one of the three resonant frequencies is the 2.4G frequency band of the Wi-Fi signal. When the first radiator of the first conductive branch 113 radiates the first radio frequency signal, the system efficiency and the radiation efficiency of each operating frequency band of each first radio frequency signal meet the communication requirements.

In some embodiments, a plurality of resonant frequencies are generated in the second conductive branch 115 under the resonance adjustment of the second resonant circuit 213, such that the second radiator of the second conductive branch 115 may radiate the second radio frequency signal with a plurality of operating frequency bands.

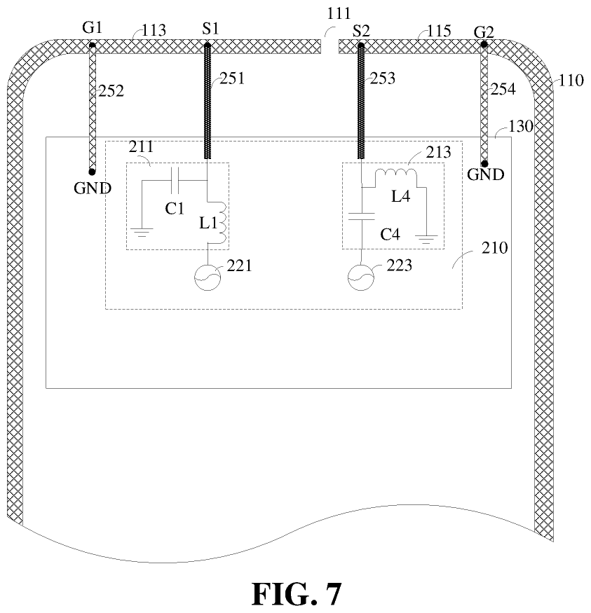

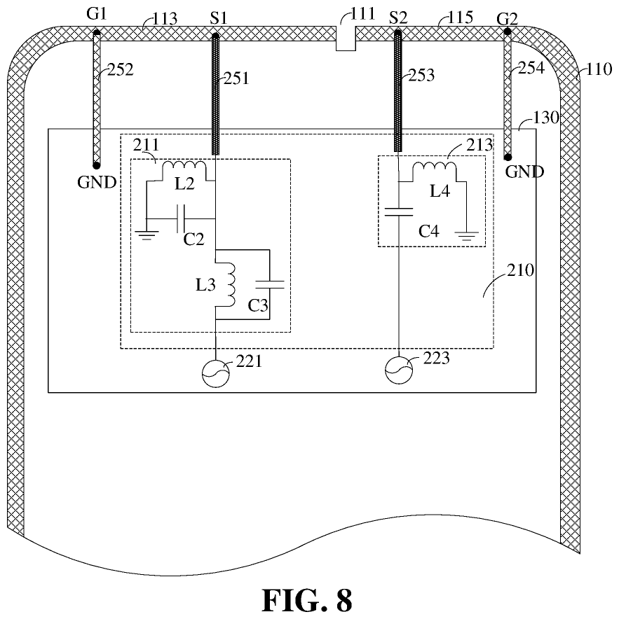

As shown in FIGS. 7 and 8, in some embodiments, the second resonant circuit 213 is a high-pass filter circuit. It should be appreciated that, the high-pass filter circuit is configured as: when the second current signal passes, the second resonant circuit 213 is in an ON state or in a conductive state; and a non-second current signal with a frequency lower than that corresponding to the second current signal is blocked and could not pass the second resonant circuit 213.

Specifically, the second resonant circuit 213 may include a fourth capacitor C4 and a fourth inductor L4. A first end of the fourth capacitor C4 may be connected to the second feed point S2 and a first end of the fourth inductor L4. The other end of the fourth capacitor C4 is connected to the second signal source 223. A second end of the fourth inductor L4 is grounded.

It should be noted that, the high-pass filter circuit may be formed of other components, and is not limited to the embodiments illustrated in the present disclosure.

In some embodiments of the present disclosure, as shown in FIGS. 4a-4b and FIG. 6, under an action of the second resonant circuit 213, the second current signal may be fed into the second conductive branch 115 via the second feed point S2, and excite, in the second conductive branch 115, resonant frequencies resonating in the N78 frequency band and the N79 frequency band of the 5G signal and in the 5G frequency band of the Wi-Fi signal. In this way, the second radiator of the second conductive branch 115 may realize the second radio frequency signal that radiates the N78 frequency band and the N79 frequency band of the 5G signal and the 5G frequency band of the Wi-Fi signal. As shown in FIG. 6, a curve 601 illustrate the S11 coefficient of the first radio frequency signal, a curve 602 illustrate the S11 coefficient of the second radio frequency signal.

In some embodiments, a second ground-returning point G2 is provided on the second conductive branch 115. The second ground-returning point G2 is arranged at a side of the second feed point S2 away from the slot 111. The second conductive branch 115 between the slot 111 and the second ground-returning point G2 may form the second radiator.

The second signal source 223 and the second resonant circuit 213 may both be arranged on the substrate 130. The second resonant circuit 213 may be coupled to the second conductive branch 115 via a second electrical feeding part 253. A coupling point between the second electrical feeding part 253 and the second conductive branch 115 may be configured as the second feed point S2. The second electrical feeding part 253 may be a conductive elastic sheet or a screw. The second feed point S2 may be connected to the second resonant circuit 213 through the conductive elastic sheet or the screw. The second current signal output from the second signal source 223 may pass through the second resonant circuit 213, and then be fed into the second conductive branch 115 via the second feed point S2 by feeding of the elastic sheet or the screw. In this way, a plurality of resonant frequencies may be excited in the second conductive branch 115, thereby generating radiation. That is, the second radiator of the second conductive branch 115 may be caused to radiate the second radio frequency signal with a plurality of operating frequency bands.

In some embodiments, the second ground-returning point G2 may be connected to the ground layer of the substrate 130 through the second connection portion 254, such that a connectivity of the second ground-returning point G2 with the ground may be realized. The second connection portion 254 may be a conductor or a flexible circuit board. The conductor may be an elastic sheet or a screw or the like. The second connection portion 254 may also be a connection arm. The connection arm may be made from the same material as the second conductive branch 115. For example, the second connection portion 254 and the second conductive branch 115 may be integrally formed, to simplify the structure of the antenna assembly.

The operating frequency bands of the first radio frequency signal may be varied by changing a length dimension of the first radiator. The operating frequency bands of the second radio frequency signal may be varied by changing a length dimension of the second radiator. The longer the radiator is, the lower is the frequency band that can be covered by the radiator. In the present disclosure, the length dimension of the first radiator may be greater than that of the second radiator. The length dimension may be appreciated as a dimension in an extending direction of the conductive frame on the electronic device.

It should be noted that, frequencies within a range of 7-13% of a resonant frequency may be regarded as an operating bandwidth of the antenna. For example, when the resonant frequency of the antenna is 1800 MHz, and the operating bandwidth is 10% above and below around the resonant frequency, then an operating frequency band of the antenna may be in the range of 1620 MHz-1980 MHz.

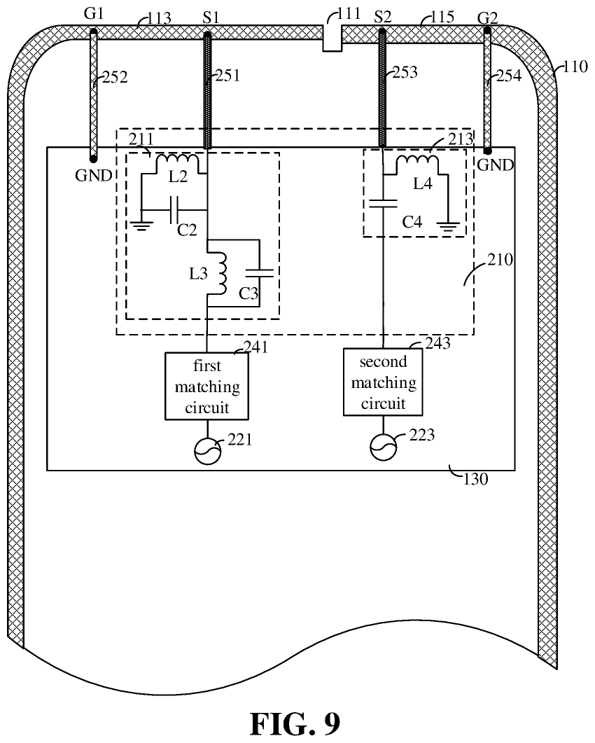

As shown in FIG. 9, in some embodiments, a first matching circuit 241 configured for adjusting the first current signal may be arranged between the first conductive branch 113 and the first signal source 221. The first matching circuit 241 may be configured for adjusting an input impedance of the first radiator, so as to increase a transmitting performance of the first radiator.

A second matching circuit 243 configured for adjusting the radio frequency signal of the second current signal may further be arranged between the second conductive branch 115 and the second signal source 223. The second matching circuit 243 may be configured for adjusting an input impedance of the second radiator, so as to increase a transmitting performance of the second radiator.

Specifically, each of the first matching circuit 241 and the second matching circuit 243 may include a combination of a capacitor rand/or an inductor or the like. In some embodiments of the present disclosure, specific composition forms of the first matching circuit 241 and the second matching circuit 243 are not further limited.

It should be noted that, the first feed point S1 may be arranged closer to the slot 111 than a middle position of the first conductive branch 113, the second feed point S2 may also be arranged closer to the slot 111 than a middle position of the second conductive branch 115. It should be understood that, a specific position of the first feed point S1 may be associated with the first matching circuit 241. That is, the specific position of the first feed point S1 may be arranged based on the first matching circuit 241. Accordingly, a specific position of the second feed point S2 may be associated with the second matching circuit 243. That is, the specific position of the second feed point S2 may be arranged based on the second matching circuit 243.

In some embodiments, the conductive frame 110 may be divided into the first conductive branch 113 and the second conductive branch 115 through defining the slot 111 in the conductive frame 110. The first resonant circuit 211 may tune the first current signal fed to a middle position of the first conductive branch 113, such that a plurality of resonant frequencies resonating in the MHB frequency band of the LTE signal, the L1 frequency band of the GPS signal and the 2.4G frequency band of the Wi-Fi signal may be excited in the first conductive branch 113. The second resonant circuit 213 may tune the second current signal fed to a position of the second conductive branch 115 closer to the slot 111 than a middle position of the second conductive branch 115, such that a plurality of resonant frequencies resonating in the N78 frequency band and the N79 frequency band of the 5G signal and in the 5G frequency band of the Wi-Fi signal may be excited in the second conductive branch 115. In this way, the design of the antenna having dual conductive branches sharing the common aperture may be achieved. The GPS signal, the MHB signal, the N78 signal, the N79 signal and the Wi-Fi signal may share the common slot, such that space-utilizing rates of the slot and the whole device may be increased.

In some embodiments, the number of slots 111 defined in the conductive frame 110 may be multiple. In some embodiments, two slots are taken as an example for description. The two slots may include a first slot and a second slot. The conductive frame 110 may be divided into the first conductive branches 113, the second conductive branches 115 and a third conductive branch separating from each other by the first slot and the second slot. Each of these conductive branches may be correspondingly provided with a feed point and a ground-returning point. The first radiator for radiating the first radio frequency signal may be integrated in the first conductive branch 113. The second radiator for radiating the second radio frequency signal may be integrated in the second conductive branch 115. A third radiator for radiating a third radio frequency signal may be integrated in the third conductive branch. The third radio frequency signal may be a 2G signal, a 3G signal, a Bluetooth signal, etc.

Further, each feed point may be connected to a filter circuit through the conductive elastic sheet or the screw, and connected to a corresponding signal source through the resonant circuit. Each signal source may feed the current signal to a corresponding conductive branch through the resonant circuit, the conductive elastic sheet or the screw and the feed point, such that a one-quarter current or currents in other modes may be excited on a conductive branch (the radiator) between the slot and the ground-returning point. In this way, a radiation may be generated, and different radio signals may be radiated.

By analogy, when N (N≥2) slots 111 are defined in the conductive frame 110, the conductive frame 110 may be divided into N+1 independent conductive branches. Correspondingly, N+1 resonant circuits and N+1 signal sources may also be arranged. N+1 radiators may each be integrated in one of the N+1 independent conductive branches correspondingly, and configured to radiate N+1 radio frequency signals. Each of these radio frequency signals may have different operating frequency bands.

An electronic device 10 is further provided in some embodiments of the present disclosure. The electronic device 10 may include the substrate 130 and the antenna assembly as described in any of the foregoing embodiments. The substrate 130 may be accommodated in a cavity enclosed by the conductive frame 110. The resonant module 210 and the signal source module 220 may be arranged on the substrate 130.

When the antenna assembly is applied in the electronic device 10, the first conductive branch 113 and the second conductive branch 115 may share the same slot 111, such that the first conductive branch 113 may radiate the first radio frequency signal and the second conductive branch 115 may radiate the second radio frequency signal at the same time. In this way, the space-utilizing rates of the slot 111 and the conductive frame 110 of the electronic device 10 may be increased. In addition, there is no need to design an antenna radiator separately, thereby reducing the thickness of the cellphone.

As an example, due to the design of the common-aperture-shared antenna, the GPS signal, the MHB signal, the N78 signal, the N79 signal and the Wi-Fi signal may share the same slot, such that the first radiator and the second radiator may be integrated on the first frame or the third frame of the electronic device 10. In this way, the utilizing rate of the top frame or the utilizing rate of the bottom frame may be increased, and the pressure of integrating the antenna assembly on the side frames may be reduced. Therefore, the profile heights of the side frames may be reduced, and the profile heights of the side frames may be reduced to values less than 1 mm. The profile heights of the side frames may be regarded as the metal widths of the metal frame 110 in the thickness direction of the electronic device 10. The profile height of the conductive frame 110 is one of the main factors affecting the radiating efficiency of the conductive frame 110. Under the background that the curvature of the side surface of the curved screen is getting larger and larger, the profile heights of the side frames may be limited, resulting in the antenna clearances being greatly reduced. By adopting the design of the common-aperture-shared antenna according to the embodiments of the present disclosure, the antenna assembly may be integrated on the top frame or the bottom frame, so as to ensure that the antenna has an enough clearance. In addition, by arranging the first resonant circuit in the antenna assembly, the first current signal for generating a plurality of resonant frequencies may be excited in the first conductive branch, such that the first radiator of the first conductive branch may simultaneously radiate the first radio frequency signal including a plurality of operating frequency bands. In this way, a design requirement of multiple frequency bands and multiple antennas may be satisfied with the top frame or the bottom frame having a limited radiator length.

Any reference to a memory, a storage, a database or other media made in the embodiments of the present disclosure may include a non-volatile memory and/or a volatile memory. Suitable non-volatile memory may include a read only memory (ROM), a programmable ROM (PROM), an electrically programmable ROM (EPROM) an electrically erasable programmable ROM (EEPROM), or a flash memory. The volatile memory may include a random access memory (RAM), which may be configured as an external cache memory. As illustration but not limitation, RAM nay be available in various forms, such as a static RAM (SRAM), a dynamic RAM (DRAM), a synchronous DRAM (SDRAM), a double data rate SDRAM (DDR SDRAM), an enhanced SDRAM (ESDRAM), a synchronous Link (Synchlink) DRAM (SLDRAM), a Memory Bus (Rambus) Direct RAM (RDRAM), a Direct Rambus Dynamic RAM (DRDRAM), and a Rambus Dynamic RAM (RDRAM).

Each technical feature in the above embodiments may be combined arbitrarily. For a concise description, all possible combinations of various technical features in the above embodiments are not described. Each combination of these technical features which has no contradiction should be regarded within a scope recited by the specification.

Only some implementations of the present disclosure are described in the above embodiments, descriptions of which are relatively specific and detailed but should not be construed as limitations to a patent scope of the present disclosure. It should be noted that those skilled in the art may make some modifications and improvements without departing from a concept of the present disclosure. All of the modifications and improvements belong to a protection scope of the present disclosure. Therefore, the protection scope of the present disclosure shall be subject to the appended claims.

What is claimed is:

1. An antenna assembly, comprising:
a conductive frame, defining at least one slot, wherein the conductive frame is divided by the slot at least into a first conductive branch and a second conductive branch separate from each other, a first feed point is provided on the first conductive branch, and a second feed point is provided on the second conductive branch;
a resonant module, comprising a first resonant circuit and a second resonant circuit; and
a signal source module, comprising a first signal source and a second signal source;
wherein, the first signal source is coupled to the first conductive branch via the first resonant circuit and the first feed point, and feeds a first current signal to the first conductive branch, such that a plurality of resonant frequencies are generated in the first conductive branch, and a first radio frequency signal including a plurality of operating frequency bands is radiated;
the second signal source is coupled to the second conductive branch via the second resonant circuit and the second feed point, and feeds a second current signal to the second conductive branch, such that at least one resonant frequency is generated in the second conductive branch, and a second radio frequency signal including at least an operating frequency band is radiated.

2. The antenna assembly as claimed in claim 1, wherein
the first resonant circuit comprises a low-pass filter circuit, wherein two resonant frequencies are generated in the first conductive branch under resonance adjustment of the first resonant circuit.

3. The antenna assembly as claimed in claim 2, wherein
the low-pass filter circuit comprises a first capacitor and a first inductor, wherein,
a first end of the first inductor is connected to a first end of the first capacitor and the first feed point,
a second end of the first inductor is connected to the first signal source, and
a second end of the first capacitor is grounded.

4. The antenna assembly as claimed in claim 2, wherein
one of the two resonant frequencies is an L1 frequency band of a GPS signal, and
the other one of the two resonant frequencies is a 2.4G frequency band of a Wi-Fi signal.

5. The antenna assembly as claimed in claim 1, wherein
the first resonant circuit comprises a band-stop and band-pass circuit, wherein
three resonant frequencies are generated in the first conductive branch under resonance adjustment of the first resonant circuit.

6. The antenna assembly as claimed in claim 5, wherein
the band-stop and band-pass circuit comprises a second capacitor, a third capacitor, a second inductor and a third inductor, wherein
a first end of the second inductor and a first end of the second capacitor are grounded;
a second end of the second inductor is connected to the first feed point, a second end of the second capacitor, a first end of the third capacitor and a first end of the third inductor; and
a second end of the third capacitor and a second end of the third inductor are connected to the first signal source.

7. The antenna assembly as claimed in claim 5, wherein
a first one of the three resonance frequencies is an L1 frequency band of a GPS signal,
a second one of the three resonance frequencies is a signal frequency band with a medium-high frequency of an LTE signal, and
a third one of the three resonance frequencies is a 2.4G frequency band of a Wi-Fi signal.

8. The antenna assembly as claimed in claim 1, wherein
a plurality of resonant frequencies are generated in the second conductive branch under resonance adjustment of the second resonant circuit.

9. The antenna assembly as claimed in claim 8, wherein
the second resonant circuit is a high-pass filter circuit.

10. The antenna assembly as claimed in claim 9, wherein
the second resonant circuit comprises a fourth capacitor and a fourth inductor, wherein
a first end of the fourth capacitor is connected to a first end of the fourth inductor and the second feed point;
a second end of the fourth capacitor is connected to the second signal source; and
a second end of the fourth inductor is grounded.

11. The antenna assembly as claimed in claim 8, wherein
resonant frequencies resonating in an N78 frequency band and an N79 frequency band of a 5G signal and in a 5G frequency band of a Wi-Fi signal are excited in the second conductive branch under resonance adjustment of the second resonant circuit.

12. The antenna assembly as claimed in claim 1, wherein
a first ground-returning point is provided on the first conductive branch,
the first feed point is provided in a middle position of the first conductive branch,
the first ground-returning point is arranged away from the slot, and
the first conductive branch between the slot and the first ground-returning point forms a first radiator.

13. The antenna assembly as claimed in claim 12, wherein
the first resonant circuit is coupled to the first conductive branch via a first electrical feeding part; and
a coupling point between the first electrical feeding part and the first conductive branch is configured as the first feed point.

14. The antenna assembly as claimed in claim 1, wherein
a second ground-returning point is provided on the second conductive branch,
the second ground-returning point is arranged at a side of the second feed point away from the slot, and
the first conductive branch between the slot and the second ground-returning point forms a second radiator.

15. The antenna assembly as claimed in claim 14, wherein
the second resonant circuit is coupled to the second conductive branch via a second electrical feeding part; and
a coupling point between the second electrical feeding part and the second conductive branch is configured as the second feed point.

16. The antenna assembly as claimed in claim 1, wherein
a first matching circuit configured for adjusting impedance is further arranged between the first feed point and the first signal source; and
a second matching circuit configured for adjusting impedance is further arranged between the second feed point and the second signal source.

17. The antenna assembly as claimed in claim 1, wherein
a length dimension of the first conductive branch is greater than that of the second conductive branch.

18. The antenna assembly as claimed in claim 1, wherein
operating frequency bands of the first radio frequency signal comprises: two operating frequency bands of an LTE signal; an operating frequency band of a satellite positioning signal; and a first operating frequency band of a Wi-Fi signal; and
operating frequency bands of the second radio frequency signal comprises: two operating frequency bands of a 5G signal; and a second operating frequency band of the Wi-Fi signal.

19. An electronic device, comprising:
a substrate;
a conductive frame, defining at least one slot, wherein the conductive frame is divided by the slot at least into a first conductive branch and a second conductive branch separate from each other, a first feed point is provided on the first conductive branch, and a second feed point is provided on the second conductive branch;
a resonant module, comprising a first resonant circuit and a second resonant circuit; and
a signal source module, comprising a first signal source and a second signal source;
wherein, the first signal source is coupled to the first conductive branch via the first resonant circuit and the first feed point, and feeds a first current signal to the first conductive branch, such that a plurality of resonant frequencies are generated in the first conductive branch, and a first radio frequency signal including a plurality of operating frequency bands is radiated;
the second signal source is coupled to the second conductive branch via the second resonant circuit and the second feed point, and feeds a second current signal to the second conductive branch, such that at least one resonant frequency is generated in the second conductive branch, and a second radio frequency signal including at least an operating frequency band is radiated;
the substrate is accommodated in a cavity enclosed by the conductive frame, the resonant module and the signal source module are arranged on the substrate.

20. The electronic device as claimed in claim 19, wherein
the conductive frame comprises a first frame and a third frame opposite to the first frame, a second frame and a fourth frame opposite to the second frame, the second frame is connected to the first frame and the third frame, the first conductive branch and the second conductive branch are integrated in the first frame or the third frame of the electronic device.
